(19) United States
(12) Patent Application Publication
(10) Pub. No.: US 2026/0349938 A1
(43) Pub. Date: Nov. 5, 2026

(54) Data Interaction System and Method, Large-Scale Operation Processing Method, Device and Medium

(71) Applicant: SUZHOU METABRAIN INTELLIGENT TECHNOLOGY CO., LTD., Suzhou, Jiangsu (CN)

(72) Inventors: Guangkui HUANG, Suzhou, Jiangsu (CN); Rengang LI, Suzhou, Jiangsu (CN); Chuang ZHANG, Suzhou, Jiangsu (CN); Min WANG, Suzhou, Jiangsu (CN); Zhiyong XIE, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/115,536

(22) PCT Filed: Jul. 25, 2024
(86) PCT No.: PCT/CN2024/107642

§ 371 Date: Mar. 26, 2025

(30) Foreign Application Priority Data
Jul. 25, 2023 (CN) 202310915197.0

(51) Int. Cl. G06F 13/16; G06F 13/40

(52) U.S. Cl. CPC G06F 13/1668; G06F 13/1652; G06F 13/4022; G06F 2213/0026

(57) ABSTRACT

A data interaction system includes: a first processor and a second processor, configured to respectively execute different data operations so as to generate operation results and operation completion indications; a first memory, configured to store the operation results; and a read/write controller, being internally provided with a second memory configured to store the operation completion indications and storage information of the operation results in the first memory. The read/write controller is configured to gate the first memory to communicate with a processor generating an operation result, such that the processor writes the operation result into the first memory, and when the read/write controller detects that an operation completion indication and storage information are written into the second memory, to gate the first memory to communicate with the other processor so as to read the operation result from the first memory.

### CROSS-REFERENCE TO RELATED APPLICATION

The present disclosure is a national stage filing under 35 U.S.C. § 371 of international application number PCT/CN 2024/107642, filed Jul. 25, 2024, which claims priority to Chinese Patent Application No. 202310915197.0, filed to the China National Intellectual Property Administration on Jul. 25, 2023 and entitled “Data interaction system and Method, Large-scale operation processing method, Device and Medium”, the disclosure of which is hereby incorporated by reference in its entirety.

### TECHNICAL FIELD

The present disclosure relates to the technical field of communications, and in particular, to a data interaction system and method, a large-scale operation processing method, a device and a medium.

### BACKGROUND

With the rapid development of new technologies, the scale of algorithms in some fields, such as Artificial Intelligence (AI) and genetic analysis, is increasing. Due to considerations in various aspects such as resource, these algorithms are divided (or segmented) to run on a plurality of processors. This division has the advantages of both reducing the difficulty in algorithm implementation on each processor and improving the overall efficiency. Additionally, some confidential algorithms are divided to run on a plurality of processors for the purpose of algorithm confidentiality. Since different algorithms may need to use data generated by other algorithms, data interaction (also referred to as data exchange in the present disclosure) may be required between different processors.

At present, a traditional method of data interaction between processors involves adding a dual-port Random Access Memory (RAM) (also known as a Dual Port Random Access Memory (DPRAM)) chip between two processors, as shown in FIG. 1. The implementation principle is that Central Processing Unit (CPU) 1 and CPU2 agree to designate a portion of the DPRAM space as a control space (the gray area in FIG. 1), with the rest being a data space. CPU1/CPU2 monitors the information in the control space to understand the data information in the data space, so as to perform correct operations. For example, if CPU1 has some data to be transmitted to CPU2, then CPU1 first writes the data to a segment of address space of the DPRAM, then writes “1” to an output control register of CPU1, and writes a starting address and a data length to the corresponding register. After detecting that “1” has been written to the control register, CPU2 reads the information of the starting address and the data length, and reads the data from the corresponding address space of the DPRAM according to the information of the starting address and the data length. However, the traditional processor data interaction method has the following defects: due to the capacity limitation of DPRAM, the amount of exchanged data is relatively small. When a large amount of data needs to be exchanged, the processor needs to write the data and the control information to the DPRAM for many times, which is not only inefficient but also wastes processor resources. Therefore, improvement is urgently needed.

### SUMMARY

In view of this, a data interaction system and method, a large-scale operation processing method, a device and a medium are provided, which may solve the above technical problems.

According to a first aspect of the embodiments of the present disclosure, a data interaction system is provided, which includes: a first processor, a second processor, a first memory, and a read-write controller.

The first processor and second processor are configured to respectively execute data operations to generate operation results and operation completion indications.

The first memory is configured to store the operation results.

The read-write controller is respectively connected to the first processor, the second processor, and the first memory, the read-write controller is internally provided with a second memory, and the second memory is configured to store the operation completion indications and storage information of the operation results in the first memory.

The read-write controller is configured to grant the processor generating the operation result to communicate with the first memory, where the processor generating the operation result is configured to write the operation result into the first memory after being granted to communicate with the first memory; and the read-write controller is configured to grant, when the read-write controller detects that the operation completion indication and the storage information are written into the second memory, the other processor to communicate with the first memory, where the other processor is configured to read, after being granted to communicate with the first memory, the operation result from the first memory based on the storage information in the second memory.

In some embodiments, the read-write controller includes a first Peripheral Component Interconnect express (PCIe) End Point (EP) and a second PCIe EP.

The first PCIe EP is connected to a PCIe Root Complex (RC) of the first processor, and the second PCIe EP is connected to a PCIe RC of the second processor.

In some embodiments, the read-write controller further includes an arbitration control unit.

The arbitration control unit is respectively connected to the first PCIe EP, the second PCIe EP, and the first memory, and the arbitration control unit is configured to grant the first processor to access the first memory through the first PCIe EP or grant the second processor to access the first memory through the second PCIe EP.

In some embodiments, the read-write controller further includes an internal logic unit, and the second memory includes a first port, a second port, and a third port.

The first port is connected to the first PCIe EP, the second port is connected to the second PCIe EP, the third port is connected to the internal logic unit, and the internal logic unit is further respectively connected to the first PCIe EP and the second PCIe EP.

In some embodiments, the first processor is configured to:
execute a first operation to generate a first operation result, and generate a first operation completion indication when execution of the first operation is completed, where the data operation executed by the first processor includes the first operation;
send a communication request to the arbitration control unit to write the first operation result into the first memory through the first PCIe EP, and acquire a starting address and a data length of the first operation result in the first memory to obtain first storage information; and
respectively write the first storage information and the first operation completion indication into a preset address of the second memory.

In some embodiments, the internal logic unit is configured to:
perform cyclic detection on the preset address of the second memory; and
send, in response to the first operation completion indication being written into the preset address, a communication request to the arbitration control unit to send a first interrupt to the second processor through the second PCIe EP.

In some embodiments, the second processor is configured to:
check, in response to receiving the first interrupt, an interrupt source of the first interrupt to read the starting address and the data length of the first operation result from the preset address of the second memory; and
send a communication request to the arbitration control unit to read the first operation result from the first memory through the second PCIe EP based on the starting address and the data length of the first operation result.

In some embodiments, the second processor is further configured to:
execute a second operation on the first operation result to generate a second operation result, and generate a second operation completion indication when execution of the second operation is completed, where the data operation executed by the second processor includes the second operation;

send a communication request to the arbitration control unit to write the second operation result into the first memory through the second PCIe EP, and acquire a starting address and a data length of the second operation result in the first memory to obtain second storage information; and
respectively write the second storage information and the second operation completion indication into the preset address of the second memory.

In some embodiments, the internal logic unit is further configured to:
send, in response to the second operation completion indication being written into the preset address, a second interrupt to the first processor through the first PCIe EP.

In some embodiments, the first processor is further configured to:
check, in response to receiving the second interrupt, an interrupt source of the second interrupt to read the starting address and the data length of the second operation result from the preset address of the second memory; and
send a communication request to the arbitration control unit to read the second operation result from the first memory through the first PCIe EP based on the starting address and the data length of the second operation result, and execute subsequent operations based on the second operation result.

In some embodiments, the arbitration control unit is configured to:
put the communication requests sent by the first processor and the second processor into a queue in chronological order; and
sequentially retrieve the communication requests from the queue, and grant a connection between the first memory and the first PCIe EP or grant a connection between the first memory and the second PCIe EP based on the communication requests.

In some embodiments, the arbitration control unit is further configured to:
grant, in response to the communication request being sent by the first processor, the connection between the first memory and the first PCIe EP; and
grant, in response to the communication request being sent by the second processor, the connection between the first memory and the second PCIe EP.

In some embodiments, the read-write controller is built using a Field Programmable Gate Array (FPGA).

In some embodiments, the arbitration control unit is a Crossbar switching unit.

In some embodiments, the first processor and the second processor are both selected from any one of a CPU, a Graphics Processing Unit (GPU), and an Application-Specific Integrated Circuit (ASIC).

In some embodiments, the first memory is a Double Data Rate Synchronous Dynamic Random Access Memory (DDRSDRAM), and the second memory is an RAM.

In some embodiments, the data interaction system further includes a third memory.

The third memory is connected to the first processor, and the third memory is a DDRSDRAM, configured to store data participating in calculation when the first processor executes the data operation.

In some embodiments, the data interaction system further includes a fourth memory.

The fourth memory is connected to the second processor, and the fourth memory is a DDRSDRAM, configured to store data participating in calculation when the second processor executes the data operation.

According to a second aspect of the embodiments of the present disclosure, a data interaction method is provided, which includes the following operations.

Data operations are executed using a first processor and a second processor.

In response to a processor, being either the first processor or the second processor, generating an operation result and an operation completion indication, a communication request is sent to a read-write controller.

The read-write controller grants, based on the communication request, the processor generating the operation result to communicate with a first memory.

The processor generating the operation result is configured to store the operation result in the first memory after being granted to communicate with the first memory, and store the operation completion indication and storage information of the operation result in the first memory in a second memory internally provided in the read-write controller.

In response to the read-write controller detecting that the operation completion indication and the storage information are written into the second memory, the other processor is granted to communicate with the first memory, where the other processor is configured to read, after being granted to communicate with the first memory, the operation result from the first memory based on the storage information in the second memory.

According to a third aspect of the embodiments of the present disclosure, a large-scale operation processing method is provided. A large-scale operation includes a first operation and a second operation in which an operation result of the first operation participates in calculation. The large-scale operation processing method includes the following operation.

The first operation and the second operation are respectively processed by the first processor and the second processor of the above data interaction system, and operation results are exchanged between the first processor and the second processor to execute subsequent operations based on the exchanged operation results.

According to a fourth aspect of the embodiments of the present disclosure, an electronic device is further provided, which includes at least one processor and a memory.

The at least one processor is provided.

The memory stores a computer program executable on the processor, and the processor performs the aforementioned data interaction method when executing the program.

According to a fifth aspect of the embodiments of the present disclosure, a computer non-volatile readable storage medium is further provided, in which a computer program is stored, and the computer program is executed by a processor to perform the aforementioned data interaction method.

According to the above data interaction system, the read-write controller is arranged between the first processor and the second processor. The read-write controller is utilized to mount the operation results from the first processor and store the operation results in the first memory. A second memory built in the read-write controller is utilized to store the storage information of the operation results and the operation completion indications. By detecting the operation completion indications, the data interaction system enables the first processor and the second processor to alternately connect to the first memory. This eliminates the need for the first processor and the second processor to perform data read-write control operations, saving computational resources and significantly enhancing the efficiency of data interaction, while offering superior versatility.

In addition, the embodiments of the present disclosure further provide a data interaction method, a large-scale operation processing method, an electronic device and a computer non-volatile readable storage medium, which may also achieve the above technical effects and will not be elaborated here.

### BRIEF DESCRIPTION OF THE DRAWINGS

In order to more clearly illustrate the embodiments of the present disclosure or the technical solutions in the related art, the drawings used in the description of the embodiments or the related art will be briefly described below. It is apparent that the drawings described below are only some embodiments of the present disclosure. Other embodiments may further be obtained by those having ordinary skill in the art according to these accompanying drawings without creative efforts.

FIG. 1 is a schematic diagram of a traditional method of data interaction between processors.

FIG. 2 is a schematic structural diagram of a data interaction system according to an embodiment of the present disclosure.

FIG. 3 is a schematic structure diagram of another data interaction system according to an embodiment of the present disclosure.

FIG. 4 is a schematic diagram of a connection of a second memory internally provided in a read-write controller according to an embodiment of the present disclosure.

FIG. 5 is a schematic structural diagram of a data interaction system with two CPUs according to an embodiment of the present disclosure.

FIG. 6 is a schematic diagram of algorithm allocation of two CPUs according to an embodiment of the present disclosure.

FIG. 7 is a schematic flowchart of a data interaction method according to another embodiment of the present disclosure.

FIG. 8 is an internal structural diagram of an electronic device according to another embodiment of the present disclosure.

FIG. 9 is structural diagram of a computer non-volatile readable storage medium according to another embodiment of the present disclosure.

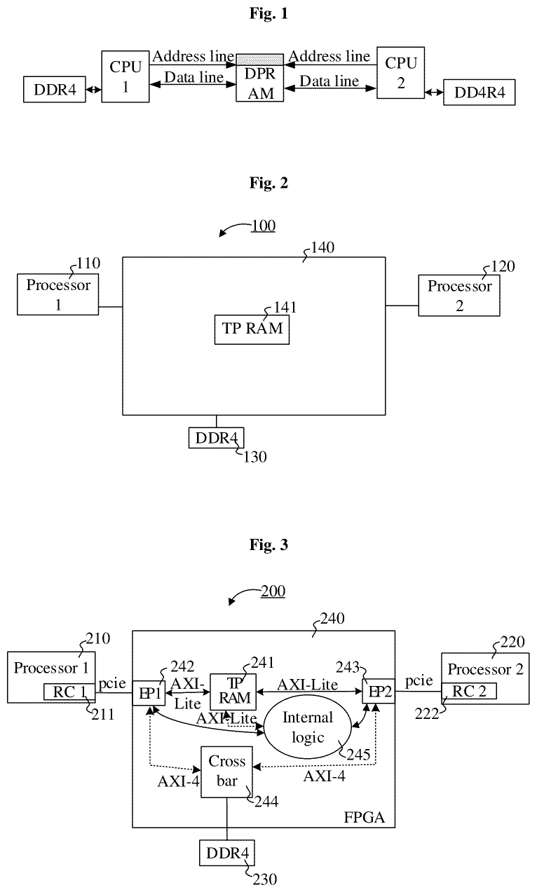

### DETAILED DESCRIPTION OF THE EMBODIMENTS

In order to make the purposes, technical solutions and advantages of the present disclosure clearer, the embodiments of the present disclosure will be further described below in detail with reference to exemplary embodiments and accompanying drawings.

It is to be noted that all expressions “first” and “second” used in the embodiments of the present disclosure are used to distinguish different entities or parameters with the same names. It can be seen that “first” and “second” are only for the convenience of description and shall not be understood as the limitation of the embodiments of the present disclosure, which will not be explained in subsequent embodiments.

In an embodiment of the present disclosure, referring to FIG. 2, a data interaction system 100 is provided, which includes: a first processor 110, a second processor 120, a first memory 130, and a read-write controller 140.

The first processor 110 and the second processor 120 are configured to respectively execute different data operations to generate operation results and operation completion indications.

In the present embodiment, the first processor 110 and the second processor 120 may both be chips configured to execute data operations in the related art, such as a CPU, a GPU, a Microprocessor (MPU)/Micro Controller Unit (MCU), a Neural Network Processor (NPU), a Tensor Processing Unit (TPU), and an ASIC. It is to be noted that the first processor 110 and the second processor 120 may be the same chip or different chips. For example, the first processor 110 and the second processor 120 may both be the CPUs, or the first processor 110 is the CPU and the second processor 120 is the ASIC. In the present embodiment, the data operations may be calculations such as data addition, data multiplication, data inversion, etc. The data operations may also be certain data processing operations in an encryption and decryption process. In an exemplary implementation process, the data operations respectively executed by the first processor 110 and the second processor 120 may be allocated according to an application scenario and a processing task. The above data operations executed by the first processor 110 and the second processor 120 are different data operations.

The first memory 130 is configured to store the operation results. The first memory 130 is preferably a Direct Memory Access (DMA). The capacity of the first memory 130 may be selected according to the size of the calculated interaction data or the requirements for the interaction scenario. For example, the capacity size may be set according to the maximum data that needs to be transmitted by the first processor 110 and the second processor 120 during data interaction. In order to ensure that the data may be exchanged in one interaction, the capacity of the first memory 130 may usually be set to be relatively large.

The read-write controller 140 is respectively connected to the first processor 110, the second processor 120, and the first memory 130, the read-write controller 140 is internally provided 140 with a second memory 141, and the second memory 141 is configured to store the operation completion indications and storage information of the operation results in the first memory 130.

In the present embodiment, the second memory 141 is preferably an RAM. Since the second memory 141 stores the storage information of the operation results, the capacity of the second memory 141 may be smaller than that of the first memory 130. The operation completion indication may be represented by a one-bit binary number. For example, after the processor completes the data operation, a signal is generated and a value of “1” is assigned to indicate that the data operation is completed. It is to be noted that the specific form and assignment method of the operation completion indication in the present embodiment are only used for illustration.

The read-write controller 140 is configured to grant the processor generating the operation result (referred to as a target processor) to communicate with the first memory 130, where the target processor is configured to write the operation result into the first memory 130 after being granted to communicate with the first memory 130. The read-write controller 140 is configured to grant, when the read-write controller 140 detects that the operation completion indication and the storage information are written into the second memory 141, the other processor to communicate with the first memory 130, where the other processor is configured to read, after being granted to communicate with the first memory 130, the operation result from the first memory 130 based on the storage information in the second memory 141.

In the present embodiment, the target processor refers to the processor generating the operation result, that is, the processor generating data to be exchanged, and the other processor refers to the processor that needs to acquire the exchanged data. Either of the first processor 110 and the second processor 120 may serve as the target processor. For example, there are three operations, i.e., operation 1, operation 2, and operation 3, that need to be sequentially executed, operation 2 requires an execution result of operation 1, and operation 3 requires an execution result of operation 2. Assuming that the first processor 110 executes operation 1 and operation 3, and the second processor 120 executes operation 2. Then when the first processor 110 completes the execution of operation 1, the first processor 110 is the target processor. Similarly, when the second processor 120 acquires the execution result of operation 1 and completes the execution of operation 2, the second processor becomes a new target processor.

According to the above data interaction system, the read-write controller is arranged between the first processor and the second processor. The read-write controller is utilized to mount the operation results from the first processor and store the operation results in the first memory. A second memory built in the read-write controller is utilized to store the storage information of the operation results and the operation completion indications. By detecting the operation completion indications, the data interaction system enables the first processor and the second processor to alternately connect to the first memory. This eliminates the need for the first processor and the second processor to perform data read-write control operations, saving computational resources and significantly enhancing the efficiency of data interaction, while offering superior versatility.

In some embodiments, referring to FIG. 3, the read-write controller 140 is built using an FPGA.

In some embodiments, in order to facilitate the understanding of the solution of the embodiments of the present disclosure, a read-write controller 240 being built using the FPGA is taken as an example for description. The connection relationships and functions of a first processor (also referred to as a first controller) 210, a second processor (also referred to as a second controller) 220, and a first memory 230 refer to the connection relationships and functions of the first processor 110, the second processor 120, and the first memory 140 in FIG. 2. The read-write controller 240 of the present embodiment is internally provided with a second memory 241 (referring to the definition of the second memory 141 in FIG. 2), and the read-write controller 240 includes a first PCIe EP 242 and a second PCIe EP 243, where the PCIe EP is an EP.

The first PCIe EP 242 is connected to a PCIe RC 211 of the first processor, and the second PCIe EP 243 is connected to a PCIe RC 221 of the second processor. The PCIe RC is an RC.

In some embodiments, referring to FIG. 3, the read-write controller 240 further includes an arbitration control unit 244.

The arbitration control unit 244 is respectively connected to the first PCIe EP 242, the second PCIe EP 243, and the first memory 230, and the arbitration control unit 244 is configured to grant the first processor 210 to access the first memory 230 through the first PCIe EP 242 or grant the second processor 220 to access the first memory 230 through the second PCIe EP 243.

In some embodiments, referring to FIG. 4, the read-write controller 240 further includes an internal logic unit 245, and the second memory 241 includes a first port 2411, a second port 2412, and a third port 2413.

The first port 2411 is connected to the first PCIe EP 242, the second port 2412 is connected to the second PCIe EP 243, the third port 2413 is connected to the internal logic unit 245, and the internal logic unit 245 is further respectively connected to the first PCIe EP 242 and the second PCIe EP 243.

In some embodiments, referring to FIG. 3 and FIG. 4, the first processor 210 is configured to:
execute a first operation to generate a first operation result, and generate a first operation completion indication when execution of the first operation is completed, where the data operation executed by the first processor 210 includes the first operation;
send a communication request to the arbitration control unit 244 to write the first operation result into the first memory 230 through the first PCIe EP 242, and acquire a starting address and a data length of the first operation result in the first memory 230 to obtain first storage information; and
respectively write the first storage information and the first operation completion indication into a preset address of the second memory 241.

In some embodiments, referring to FIG. 3 and FIG. 4, the internal logic unit 250 is configured to:
perform cyclic detection on the preset address of the second memory 230; and
send, in response to the first operation completion indication being written into the preset address, a communication request to the arbitration control unit 244 to send a first interrupt to the second processor 220 through the second PCIe EP 243.

In some embodiments, referring to FIG. 3 and FIG. 4, the second processor 220 is configured to:
check, in response to receiving the first interrupt, an interrupt source of the first interrupt to read the starting address and the data length of the first operation result from the preset address of the second memory 241; and
send a communication request to the arbitration control unit 244 to read the first operation result from the first memory 230 through the second PCIe EP 243 based on the starting address and the data length of the first operation result.

In some embodiments, referring to FIG. 3, the second processor 220 is further configured to:
execute a second operation on the first operation result to generate a second operation result, and generate a second operation completion indication when execution of the second operation is completed, where the data operation executed by the second processor 220 includes the second operation;
send a communication request to the arbitration control unit 244 to write the second operation result into the first memory 230 through the second PCIe EP 243, and acquire a starting address and a data length of the second operation result in the first memory 230 to obtain second storage information; and
respectively write the second storage information and the second operation completion indication into the preset address of the second memory 241.

In some embodiments, referring to FIG. 3, the internal logic unit 245 is further configured to:
send, in response to the second operation completion indication being written into the preset address, a second interrupt to the first processor 210 through the first PCIe EP 242.

In some embodiments, the first processor 210 is further configured to:
check, in response to receiving the second interrupt, an interrupt source of the second interrupt to read the starting address and the data length of the second operation result from the preset address of the second memory 241; and
send a communication request to the arbitration control unit 244 to read the second operation result from the first memory 230 through the first PCIe EP 242 based on the starting address and the data length of the second operation result, and execute subsequent operations based on the second operation result.

In some embodiments, the arbitration control unit 244 is configured to:
put the communication requests sent by the first processor 210 and the second processor 220 into a queue in chronological order; and
sequentially retrieve the communication requests from the queue, and grant a connection between the first memory 230 and the first PCIe EP 242 or grant a connection between the first memory 230 and the second PCIe EP 243 based on the communication requests.

In some embodiments, the arbitration control unit 244 is further configured to:
grant, in response to the communication request being sent by the first processor 210, the connection between the first memory 230 and the first PCIe EP 242; and
grant, in response to the communication request being sent by the second processor 220, the connection between the first memory 230 and the second PCIe EP 243.

In some embodiments, the arbitration control unit is a Crossbar switching unit, where a Crossbar is usually provided by an FPGA manufacturer and is an Internet Protocol (IP) module capable of connecting a plurality of AXI-4 interfaces.

In some embodiments, the first processor 210 and the second processor 220 are both selected from any one of a CPU, a GPU, and an ASIC.

In some embodiments, the first memory 230 is a DDRSDRAM, and the second memory 241 is an RAM. Preferably, the first memory 230 may use DDR4.

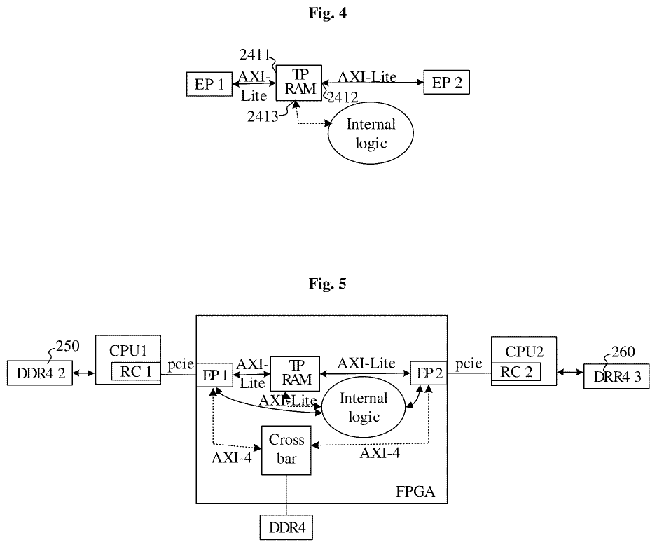

In some embodiments, referring to FIG. 5, the data interaction system further includes a third memory 250.

The third memory 250 is connected to the first processor 210, and the third memory 250 is a DDRSDRAM, configured to store data participating in calculation when the first processor 210 executes the data operation.

In some embodiments, referring to FIG. 5, the data interaction system further includes a fourth memory 260.

The fourth memory 260 is connected to the second processor 220, and the fourth memory 260 is a DDRSDRAM, configured to store data participating in calculation when the second processor 220 executes the data operation.

In still another embodiment, in order to facilitate the understanding of the solution of the present disclosure, taking a scenario where two CPUs execute an encryption operation as an example, further referring to FIG. 5, the present embodiment proposes a data interaction system that uses a PCIe channel of the FPGA in conjunction with DDR4 to solve the data interaction between the two CPUs, and the overall architecture of the data interaction system includes the following parts:

CPU1 and CPU2, wherein RC ends of the PCIe inside CPU1 and CPU2 are respectively marked as RC1 and RC2;

FPGA which includes the following components: two PCIe EPs with a Direct Memory Access (DMA) function provided by the FPGA manufacturer, respectively marked as EP1 and EP2, where EP1 is connected to RC1, and EP2 is connected to RC2; a Triple Port Random Access Memory (TPRAM), which may support a memory module with three ports for independent read-write, and is configured to control a data interaction flow; an internal logic unit, which is configured with FPGA internal processing logic of a CPU algorithm; and a Crossbar, which is an IP module capable of connecting the plurality of AXI-4 interfaces. The Crossbar may be provided by the FPGA manufacturer, the three ports of the TPRAM are respectively connected to EP1, EP2, and the internal logic unit, and the internal logic unit is further respectively connected to EP1 and EP2;
three DDR4s, wherein one DDR4 of the three DDR4s is mounted to the FPGA through the Crossbar and is recorded as DDR4 1, the Crossbar is further respectively connected to EP1 and EP2, and DDR41 may be connected to both CPU and CPU2; and the other two DDR4s are respectively mounted to CPU1 and CPU2 and are recorded as DDR4 2 and DDR4 3.

The working process of the data interaction system will be described in detail below.

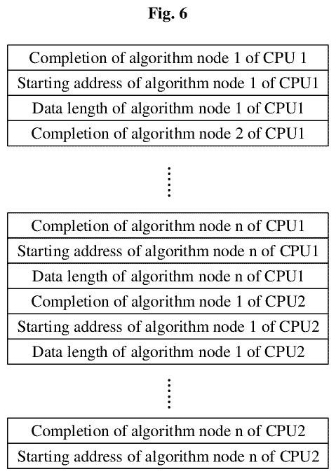

At S1, CPU1 and CPU2 determine an algorithm partitioning and data interaction flow. As shown in FIG. 6, assuming that an encryption algorithm includes 2n operations executed sequentially, and each subsequent operation depends on a result of its previous operation, the operations in odd order may be allocated to CPU1 for execution, and the operations in even order may be allocated to CPU2 for execution, so that CPU1 and CPU2 may repeatedly perform data interaction.

At S2, after completion of node 1 of the algorithm, CPU1 transmits intermediate data completed by the algorithm to DDR4 1 connected to the FPGA through a DMA flow.

At S3, CPU1 writes, into a predefined address of the TPRAM, completion indication information of node 1 of the algorithm, a starting position of DDR4 1 for storing the processed data, and a total data length.

At S4, after detecting the completion indication information of node 1 of CPU1, the internal logic unit sets corresponding interrupt indication information and sends an interrupt to CPU2.

At S5, after receiving the interrupt, CPU2 checks an interrupt source, reads the starting address and the data length of data of node 1 of CPU1 in the TPRAM, and reads the data into CPU2 through DMA for processing or application.

At S6, after data is processed, CPU2 transmits the data completed by node 1 of the algorithm of CPU2 to DDR4 1 connected to the FPGA through DMA.

At S7, CPU2 writes completion indication information of node 1 of the algorithm, a starting position of DDR4 1 where the data is located, and the total length of the data into the corresponding position of node 1 of CPU2 in the TPRAM.

At S8, after detecting the completion indication information of node 1 of CPU2, the internal logic unit sets the corresponding interrupt indication information and sends the interrupt to CPU1.

At S9, after receiving the interrupt, CPU1 checks the interrupt source, reads the starting address and the data length of the data of node 1 of CPU2 in the TPRAM, and reads the data into CPU1 through DMA for processing or application.

At S10, according to the algorithm partitioning, the above steps may be repeatedly executed until all the algorithms are executed.

The data interaction system of the present embodiment has at least the following beneficial technical effects: through the FPGA device of the dual-port PCIe, the two CPU systems work cooperatively and have good versatility; and in addition, the data interaction efficiency is improved by exchanging data through DMA, and at the same time, the capacity of DDR4 on the FPGA is large and may exchange large-scale data at one time, which can be applied to large-scale algorithm models or scenarios for algorithm protection.

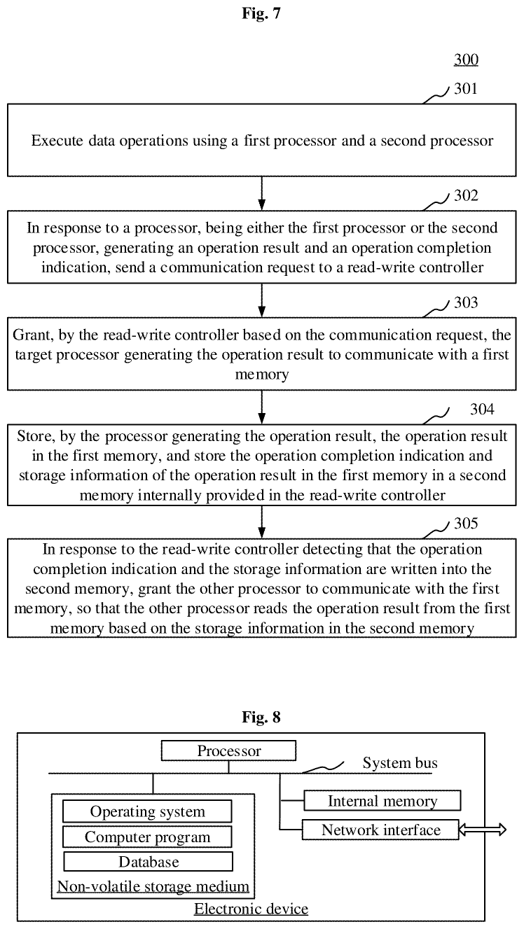

In yet another embodiment, referring to FIG. 7, the present embodiment provides a data interaction method 300, which includes the following steps.

At S301, data operations are executed using a first processor and a second processor.

At S302, in response to a processor, being either the first processor or the second processor, generating an operation result and an operation completion indication, a communication request is sent to a read-write controller.

At S303, the read-write controller grants, based on the communication request, the processor generating the operation result to communicate with a first memory.

At S304, the processor generating the operation result is configured to store the operation result in the first memory after being granted to communicate with the first memory, and store the operation completion indication and storage information of the operation result in the first memory in a second memory internally provided in the read-write controller.

At S305, in response to the read-write controller detecting that the operation completion indication and the storage information are written into the second memory, the other processor is granted to communicate with the first memory, where the other processor is configured to read, after being granted to communicate with the first memory, the operation result from the first memory based on the storage information in the second memory.

According to the above data interaction method, the read-write controller is arranged between the first processor and the second processor. The read-write controller is utilized to mount the operation results from the first processor and store the operation results in the first memory. A second memory built in the read-write controller is utilized to store the storage information of the operation results and the operation completion indications. By detecting the operation completion indications, the data interaction system enables the first processor and the second processor to alternately connect to the first memory. This eliminates the need for the first processor and the second processor to perform data read-write control operations, saving computational resources and significantly enhancing the efficiency of data interaction, while offering superior versatility.

It is to be noted that the specific limitations on the data interaction method may refer to the above limitations on the data interaction system, which will not be elaborated here.

In yet another embodiment, the present disclosure further provides a large-scale operation processing method. A large-scale operation includes a first operation and a second operation in which an operation result of the first operation participates in calculation, and the large-scale operation processing method includes: respectively processing the first operation and the second operation by the first processor and the second processor of the data interaction system of the above embodiment, and exchanging operation results between the first processor and the second processor to execute subsequent operations based on the exchanged operation results.

According to another aspect of the embodiments of the present disclosure, an electronic device is provided. The electronic device may be a server, and an internal structural diagram thereof is shown in FIG. 8. The electronic device includes a processor, a memory, a network interface, and a database which are connected through a system bus. The processor of the electronic device is configured to provide computing and control capabilities. The memory of the electronic device includes a non-volatile readable storage medium and an internal memory. The non-volatile readable storage medium stores an operating system, a computer program, and a database. The internal memory provides an environment for the operation of the operating system and the computer program in the non-volatile readable storage medium. The database of the electronic device is configured to store data. The network interface of the electronic device is configured to communicate with an external terminal via a network connection. When the computer program is executed by the processor, the above data interaction method is implemented, which includes the following steps.

Data operations are executed using a first processor and a second processor.

In response to a processor, being either the first processor or the second processor, generating an operation result and an operation completion indication, a communication request is sent to a read-write controller.

The read-write controller grants, based on the communication request, the target processor generating the operation result to communicate with a first memory.

The target processor stores the operation result in the first memory, and stores the operation completion indication and storage information of the operation result in the first memory in a second memory internally provided in the read-write controller.

In response to the read-write controller detecting that the operation completion indication and the storage information are written into the second memory, the other processor is granted to communicate with the first memory, where the other processor is configured to read, after being granted to communicate with the first memory, the operation result from the first memory based on the storage information in the second memory.

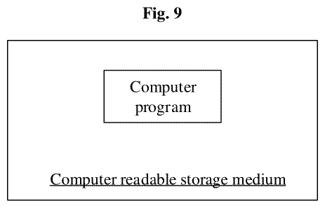

According to still another aspect of the embodiments of the present disclosure, a computer non-volatile readable storage medium is provided, as shown in FIG. 9, in which a computer program is stored. The computer program is executed by a processor to implement the above data interaction method, which includes the following steps.

Data operations are executed using a first processor and a second processor.

In response to a processor, being either the first processor or the second processor, generating an operation result and an operation completion indication, a communication request is sent to a read-write controller.

The read-write controller grants, based on the communication request, the target processor generating the operation result to communicate with a first memory.

The target processor stores the operation result in the first memory, and stores the operation completion indication and storage information of the operation result in the first memory in a second memory internally provided in the read-write controller.

In response to the read-write controller detecting that the operation completion indication and the storage information are written into the second memory, the other processor is granted to communicate with the first memory, where the other processor is configured to read, after being granted to communicate with the first memory, the operation result from the first memory based on the storage information in the second memory.

Those having ordinary skill in the art may understand that implementation of all or part of the processes in the above embodiment method may be completed by instructing related hardware through a computer program, and the computer program may be stored in a computer non-volatile readable storage medium. The computer program, when executed, may include the processes of the embodiments of the above methods. Any reference to a memory, a storage, a database, or another medium used in the embodiments provided in the present disclosure may include a non-volatile and/or volatile memory. The non-volatile memory may include a Read Only Memory (ROM), a Programmable ROM (PROM), an Electrically EROM (EPROM), an Electrically Erasable PROM (EEPROM), or a flash memory. The volatile memory may include an RAM or an external high-speed cache. It is exemplarily but unlimitedly described that RAMs in various forms may be adopted, such as a Static RAM (SRAM), a Dynamic RAM (DRAM), a Synchronous DRAM (SDRAM), a DDRSDRAM, an Enhanced SDRAM (ESDRAM), a Synchlink DRAM (SLDRAM), a Direct Rambus RAM (RDRAM), a Direct Rambus DRAM (DRDRAM), a Rambus DRAM (RDRAM), etc.

The technical features of the above-described embodiments may be arbitrarily combined. For the sake of brevity of description, all possible combinations of the technical features in the above embodiments are not described. However, as long as there is no contradiction between the combinations of these technical features, all should be considered as the scope of this description.

The above embodiments are merely illustrative of several implementations of the present disclosure with specific and detailed description, and are not to be construed as limiting the patent scope of the present disclosure. It is to be noted that a number of variations and modifications may be made by those having ordinary skill in the art without departing from the conception of the present disclosure, and all fall within the scope of protection of the present disclosure. Therefore, the scope of protection of the present disclosure should be determined by the appended claims.

1. A data interaction system, comprising:
a first processor and a second processor, wherein the first processor and the second processor are configured to respectively execute data operations to generate operation results and operation completion indications;
a first memory, wherein the first memory is configured to store the operation results; and
a read-write controller, wherein the read-write controller is respectively connected to the first processor, the second processor, and the first memory, the read-write controller is internally provided with a second memory, and the second memory is configured to store the operation completion indications and storage information of the operation results in the first memory;
the read-write controller is configured to grant the processor generating the operation result to communicate with the first memory, wherein the processor generating the operation result is configured to write the operation result into the first memory after being granted to communicate with the first memory; and the read-write controller is configured to grant, when the read-write controller detects that the operation completion indication and the storage information are written into the second memory, the other processor to communicate with the first memory, wherein the other processor is configured to read, after being granted to communicate with the first memory, the operation result from the first memory based on the storage information in the second memory.

2. The data interaction system according to claim 1, wherein the read-write controller comprises a first Peripheral Component Interconnect express (PCIe) End Point (EP) and a second PCIe EP; and
the first PCIe EP is connected to a PCIe Root Complex (RC) of the first processor, and the second PCIe EP is connected to a PCIe RC of the second processor.

3. The data interaction system according to claim 2, wherein the read-write controller further comprises an arbitration control unit; and
the arbitration control unit is respectively connected to the first PCIe EP, the second PCIe EP, and the first memory, and the arbitration control unit is configured to grant the first processor to access the first memory through the first PCIe EP or grant the second processor to access the first memory through the second PCIe EP.

4. The data interaction system according to claim 3, wherein the read-write controller further comprises an internal logic unit, and the second memory comprises a first port, a second port, and a third port; and
the first port is connected to the first PCIe EP, the second port is connected to the second PCIe EP, the third port is connected to the internal logic unit, and the internal logic unit is further respectively connected to the first PCIe EP and the second PCIe EP.

5. The data interaction system according to claim 4, wherein the first processor is configured to:
execute a first operation to generate a first operation result, and generate a first operation completion indication when execution of the first operation is completed, wherein the data operation executed by the first processor comprises the first operation;
send a communication request to the arbitration control unit to write the first operation result into the first memory through the first PCIe EP, and acquire a starting address and a data length of the first operation result in the first memory to obtain first storage information; and
respectively write the first storage information and the first operation completion indication into a preset address of the second memory.

6. The data interaction system according to claim 5, wherein the internal logic unit is configured to:
perform cyclic detection on the preset address of the second memory; and
send, in response to the first operation completion indication being written into the preset address, a communication request to the arbitration control unit to send a first interrupt to the second processor through the second PCIe EP.

7. The data interaction system according to claim 6, wherein the second processor is configured to:
check, in response to receiving the first interrupt, an interrupt source of the first interrupt to read the starting address and the data length of the first operation result from the preset address of the second memory; and
send a communication request to the arbitration control unit to read the first operation result from the first memory through the second PCIe EP based on the starting address and the data length of the first operation result.

8. The data interaction system according to claim 7, wherein the second processor is further configured to:
execute a second operation on the first operation result to generate a second operation result, and generate a second operation completion indication when execution of the second operation is completed, wherein the data operation executed by the second processor comprises the second operation;
send a communication request to the arbitration control unit to write the second operation result into the first memory through the second PCIe EP, and acquire a starting address and a data length of the second operation result in the first memory to obtain second storage information; and
respectively write the second storage information and the second operation completion indication into the preset address of the second memory.

9. The data interaction system according to claim 8, wherein the internal logic unit is further configured to:
send, in response to the second operation completion indication being written into the preset address, a second interrupt to the first processor through the first PCIe EP.

10. The data interaction system according to claim 9, wherein the first processor is further configured to:
check, in response to receiving the second interrupt, an interrupt source of the second interrupt to read the starting address and the data length of the second operation result from the preset address of the second memory; and
send a communication request to the arbitration control unit to read the second operation result from the first memory through the first PCIe EP based on the starting address and the data length of the second operation result, and execute subsequent operations based on the second operation result.

11. The data interaction system according to claim 10, wherein the arbitration control unit is further configured to:
put the communication requests sent by the first processor and the second processor into a queue in chronological order; and
sequentially retrieve the communication requests from the queue, and grant a connection between the first memory and the first PCIe EP or grant a connection between the first memory and the second PCIe EP based on the communication requests.

12. The data interaction system according to claim 11, wherein the arbitration control unit is further configured to:
grant, in response to the communication request being sent by the first processor, the connection between the first memory and the first PCIe EP; and
grant, in response to the communication request being sent by the second processor, the connection between the first memory and the second PCIe EP.

13. The data interaction system according to claim 4, wherein the read-write controller is built using a Field Programmable Gate Array (FPGA).

14. The data interaction system according to claim 13, wherein the arbitration control unit is a Crossbar switching unit.

15. The data interaction system according to claim 1, wherein
the first processor and the second processor are both selected from any one of a Central Processing Unit (CPU), a Graphics Processing Unit (GPU), and an Application-Specific Integrated Circuit (ASIC);
or,
the first memory is a Double Data Rate Synchronous Dynamic Random Access Memory (DDRSDRAM), and the second memory is a Random Access Memory (RAM).

16. (canceled)

17. The data interaction system according to claim 1, further comprising a third memory;
wherein the third memory is connected to the first processor, and the third memory is a DDRSDRAM, configured to store data participating in calculation when the first processor executes the data operation.

18. The data interaction system according to claim 1, further comprising a fourth memory;
wherein the fourth memory is connected to the second processor, and the fourth memory is a DDRSDRAM, configured to store data participating in calculation when the second processor executes the data operation.

19. A data interaction method, comprising:
executing data operations using a first processor and a second processor;
in response to a processor, being either the first processor or the second processor, generating an operation result and an operation completion indication, sending a communication request to a read-write controller;
granting, by the read-write controller based on the communication request, the processor generating the operation result to communicate with a first memory;
configuring the processor generating the operation result to store the operation result in the first memory after being granted to communicate with the first memory, and store the operation completion indication and storage information of the operation result in the first memory in a second memory internally provided in the read-write controller; and
in response to the read-write controller detecting that the operation completion indication and the storage information are written into the second memory, granting the other processor to communicate with the first memory, wherein the other processor is configured to read, after being granted to communicate with the first memory, the operation result from the first memory based on the storage information in the second memory.

20. A large-scale operation processing method, wherein a large-scale operation comprises a first operation and a second operation in which an operation result of the first operation participates in calculation, and the large-scale operation processing method comprises:
respectively processing the first operation and the second operation by the first processor and the second processor of the data interaction system according to claim 1, and exchanging operation results between the first processor and the second processor to execute subsequent operations based on the exchanged operation results.

21. (canceled)

22. A computer non-volatile readable storage medium, in which a computer program is stored, wherein the computer program is executed by a processor to perform steps comprising:
executing data operations using a first processor and a second processor;
in response to a processor, being either the first processor or the second processor, generating an operation result and an operation completion indication, sending a communication request to a read-write controller;
granting, by the read-write controller based on the communication request, the processor generating the operation result to communicate with a first memory;
configuring the processor generating the operation result to store the operation result in the first memory after being granted to communicate with the first memory, and store the operation completion indication and storage information of the operation result in the first memory in a second memory internally provided in the read-write controller; and
in response to the read-write controller detecting that the operation completion indication and the storage information are written into the second memory, granting the other processor to communicate with the first memory, wherein the other processor is configured to read, after being granted to communicate with the first memory, the operation result from the first memory based on the storage information in the second memory.
